(19) United States
(12) Patent Application Publication
(10) Pub. No.: US 2024/0135333 A1
(43) Pub. Date: Apr. 25, 2024

(54) Business System and Method for Managing Client Contact and Interaction Data

(71) Applicants: Greg Yarbrough, San Antonio, TX (US); Sandi Yarbrough, San Antonio, TX (US)

(72) Inventors: Greg Yarbrough, San Antonio, TX (US); Sandi Yarbrough, San Antonio, TX (US)

(21) Appl. No.: 18/161,384

(22) Filed: Jan. 30, 2023

Related U.S. Application Data
(60) Provisional application No. 63/417,429, filed on Oct. 19, 2022.

(51) Int. Cl. G06Q 10/1093

(52) U.S. Cl. CPC G06Q 10/1097

(57) ABSTRACT

A client contact and interaction system and method of managing client contact and interaction data. The system generates individualized action plans for businesses based on inputted business service data into a business process template. The individualized action plans are securely accessed via a task dashboard hosted on a server. The action plans are customizable to create a calendar of client-related and personal tasks that may require daily, weekly, monthly, or yearly review and action by the system user. The user may perform an action for each of the plurality of tasks at the required interval. The method allows the user to model a plurality of steps within a business process for managing the client contact and interaction data.

### CROSS-REFERENCE TO RELATED APPLICATION

The present application claims priority to, and the benefit of, U.S. Provisional Application No. 63/417,429, which was filed on Oct. 19, 2022, and is incorporated herein by reference in its entirety.

### FIELD OF THE INVENTION

The present invention generally relates to systems and methods of performing business functions. More specifically, the present invention relates to systems and methods of managing client contact and interaction data within the context of a defined business process or goal with an action plan for efficiently managing daily tasks. Accordingly, the present specification makes specific reference thereto. However, it is to be appreciated that aspects of the present invention are also equally amenable to other like applications, devices and methods of manufacture.

### BACKGROUND

An independent or small business owner may struggle to maintain effective engagement with their client base. They may easily overlook critical events and meetings and may fail to preserve a digital footprint in lieu of sticky notes and stacks of papers. Further, there exists a gap in providing lightweight customer relationship management (CRM) and business process features to individual business owners at a reasonable cost without requiring an information technology (IT) staff or dedicated trained professionals to operate client management systems.

CRM is a process in which a business administers its interactions with customers, typically using data analysis to study large amounts of information. Existing CRM systems generally compile data from a range of different communication channels. These systems allow businesses to learn more about and cater to their target audiences. The concepts, procedures, and rules that a business follows when communicating with its consumers are referred to as CRM. These platforms cover direct contact with customers, such as sales and service-related operations, forecasting, and the analysis of consumer patterns and behaviors. CRM systems are designed to improve the overall efficiency and profitability of a business.

While is common for larger and more sophisticated businesses to have the resources and manpower to utilize these CRM systems, many smaller business entities do not. These systems can be expensive and complicated to use and maintain. As technology continuously evolves, smaller and independent businesses are often left behind. Further, most small businesses do not have an IT staff that would typically be necessary to run and manage such systems.

Therefore, there exists a long-felt need in the art for a business software system for performing CRM functions that do not require oversight by specialized or dedicated professionals. There also exists a long-felt need in the art for a business software system that enables a user to manage their client contact and interaction data within the context of a defined business process or goal. There also exists a long-felt need in the art for a business software system that enables an action plan dashboard with notifications of daily tasks that need to be completed to maintain efficiency.

In this manner, the improved business software system of the present invention accomplishes all of the foregoing objectives, thereby providing an easy solution for performing CRM functions. A primary feature of the present invention is a platform and method that enables businesses to manage their CRM data within the context of a defined business process or goal. The system and method provides basic CRM and business process features for smaller businesses that do not have a dedicated IT staff. Finally, the improved business software system and method of the present invention is capable of improving business efficiency via an action plan dashboard configured to ensure that daily tasks are completed on time.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a computer system. The computer system is configured to managing client contact and interaction data for a business. The computer system comprises at least one processor in communication with a non-transitory computer-readable storage medium containing instructions for implementing a client contact and interaction system.

The client contact and interaction system comprises a task dashboard application and a process template for generating a plurality of action plans. Each of the plurality of action plans is an individualized action plan created from the process template using a plurality of business service data importable to the task dashboard application from a client. Each individualized action plan comprises a plurality of tasks viewable through the task dashboard application on a Task Dashboard. The plurality of tasks are dated tasks based on the imported plurality of business service data and accessible via a calendar.

A user can access the client contact and interaction system via an authentication component for security. The user can then perform a plurality of business operations on each of the plurality of tasks when due. The plurality of business operations are actions to indicate a status of if each task is complete, canceled, or postponed. Each action may be recorded and documented. The user may also update the client on the status of each task and receive a feedback to the client contact and interaction system. The feedback may be user to modify the relevant individualized action plan.

The subject matter disclosed and claimed herein, in an additional embodiment thereof, comprises a method of modeling a plurality of steps within a business process for managing client contact and interaction data. The method begins by creating a client contact and interaction system. The client contact and interaction system has one or more processors and a non-transitory computer-readable storage medium containing instructions to implement the client contact and interaction system.

The method continues by creating a business process template on a task dashboard application. The task dashboard application is securely accessible to a user over a network from a client input device. The user then may import a plurality of business service data from a client. Next, the plurality of business service data is used to model a plurality of steps within the business process template to create an individualized action plan. The individualized action plan comprises a plurality of dated tasks.

The user may then perform a business operation on each of the dated tasks. The business operation may be indicating a status of if each task is complete, canceled, or postponed. Next, the method continues by receiving a feedback from a client. The feedback may be based on the individualized action plan, a status of each of the dated tasks, or a survey. Finally, the individualized action plan may be revised based on the feedback.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a multi-layered system architecture of one embodiment of a client contact and interaction system of the present invention in accordance with the disclosed architecture;

FIG. 2 illustrates a diagram showing various elements of the client contact and interaction system of the present invention in accordance with the disclosed architecture;

FIG. 3 illustrates a diagram showing various elements of a Task Dashboard of the client contact and interaction system of the present invention in accordance with the disclosed architecture;

FIG. 4 illustrates an exemplary screen displayed to a user of a task of the client contact and interaction system of the present invention in accordance with the disclosed architecture;

FIG. 5 illustrates an exemplary screen displayed to a user of plurality of actions for the task of the client contact and interaction system of the present invention in accordance with the disclosed architecture;

FIG. 6 illustrates an exemplary screen displayed to a user of the Task Dashboard of the client contact and interaction system of the present invention in accordance with the disclosed architecture;

FIG. 7 illustrates an exemplary screen displayed to a user of a process template of the client contact and interaction system of the present invention in accordance with the disclosed architecture;

FIG. 8 illustrates an exemplary screen displayed to a user of an individual action plan of the client contact and interaction system of the present invention in accordance with the disclosed architecture;

FIG. 9 illustrates an exemplary screen displayed to a user of the individual action plan of the client contact and interaction system of the present invention in accordance with the disclosed architecture;

FIG. 10 illustrates an exemplary screen displayed to a user of the individual action plan of the client contact and interaction system of the present invention in accordance with the disclosed architecture;

FIG. 11 illustrates an exemplary screen displayed to a user of the individual action plan of the client contact and interaction system of the present invention in accordance with the disclosed architecture;

FIG. 12 illustrates an exemplary screen displayed to a user of the individual action plan of the client contact and interaction system of the present invention in accordance with the disclosed architecture;

FIG. 13 illustrates an exemplary screen displayed to a user of the individual action plan of the client contact and interaction system of the present invention in accordance with the disclosed architecture;

FIG. 14 illustrates an exemplary screen displayed to a user of a plurality of tasks of the individual action plan of the client contact and interaction system of the present invention in accordance with the disclosed architecture;

FIG. 15 illustrates an exemplary screen displayed to a user of the individual action plan of the client contact and interaction system of the present invention in accordance with the disclosed architecture;

FIG. 16 illustrates an exemplary screen displayed to a user of the individual action plan of the client contact and interaction system of the present invention in accordance with the disclosed architecture;

FIG. 17 illustrates an exemplary screen displayed to a user of the individual action plan of the client contact and interaction system of the present invention in accordance with the disclosed architecture;

FIG. 18 illustrates an exemplary screen displayed to a user of the individual action plan of the client contact and interaction system of the present invention in accordance with the disclosed architecture; and

FIG. 19 illustrates a flow chart of modeling a plurality of steps within a business process for managing client contact and interaction data of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a business software system for managing client contact and other client interactions. The system is designed to be used by single and small business owners without requiring a dedicated IT staff to operate the system. The system can be used in a plurality of methods for managing client relationships. The system enables the user to adhere to a defined set of tasks within a plan, defined by a process, in order to maintain effective engagement with their client base, and subsequently manage and grow their business.

The system is a client contact and interaction system configured to provide features for secure access through user provisioning and authentication with email, password, and multi-factor authentication. Once a user is logged in, the user is presented with a primary “Task Dashboard”. This Task Dashboard represents the result of previous modeling of business processes to create action plans that result in a calendar of client-related and/or personal tasks requiring daily review and action by the system user. The dashboard is configured to provide several criteria to search and filter the list of activities to review for any specific day, beginning with the current day.

For each task in the dashboard, the user may elect to review the task by double-clicking the entry or highlighting a task and clicking a “View” button. This presents a Task record, which was previously created by system automation of a process template. The user may update the disposition of the task by selecting one of a Cancel, a Complete, or a Postpone buttons. The Cancel button indicates that the task is no longer required and may be removed from the list of active tasks. The Complete button indicates that an activity represented by the task is finished and may be documented in an associated Notes entry. If the user selects the Postpone button to postpone the task, the system requires a future date to be selected, at which point the system will automate recalculation of start dates for this task and all future tasks identified by an associated process template.

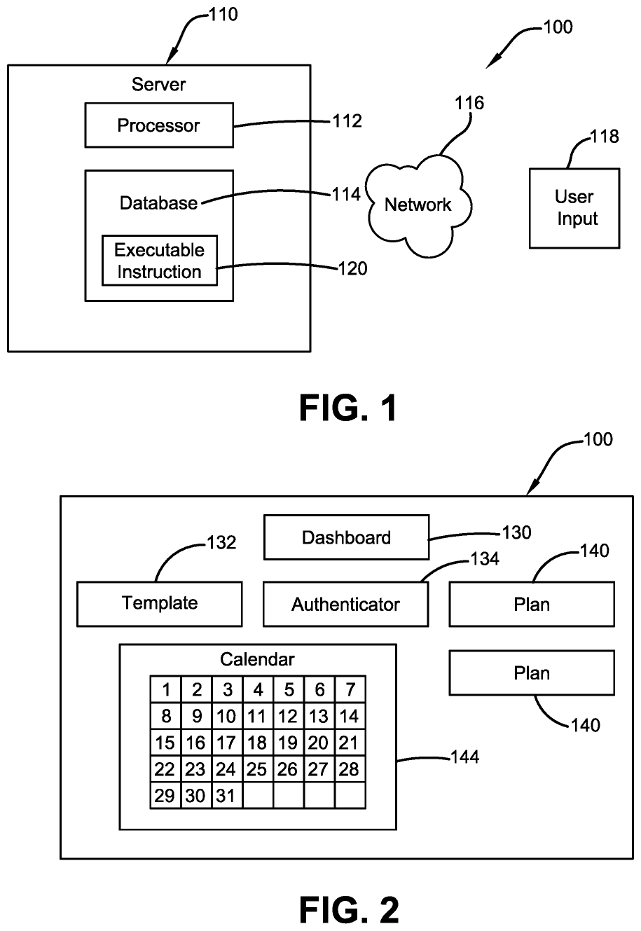

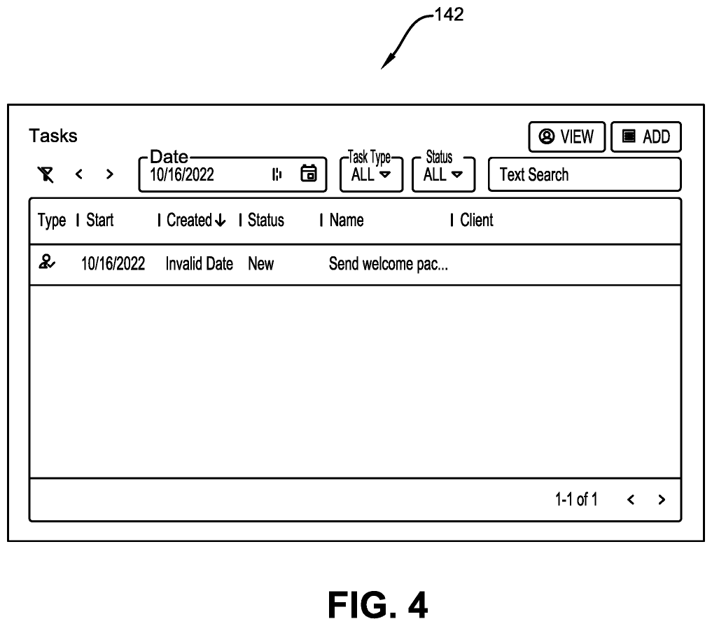

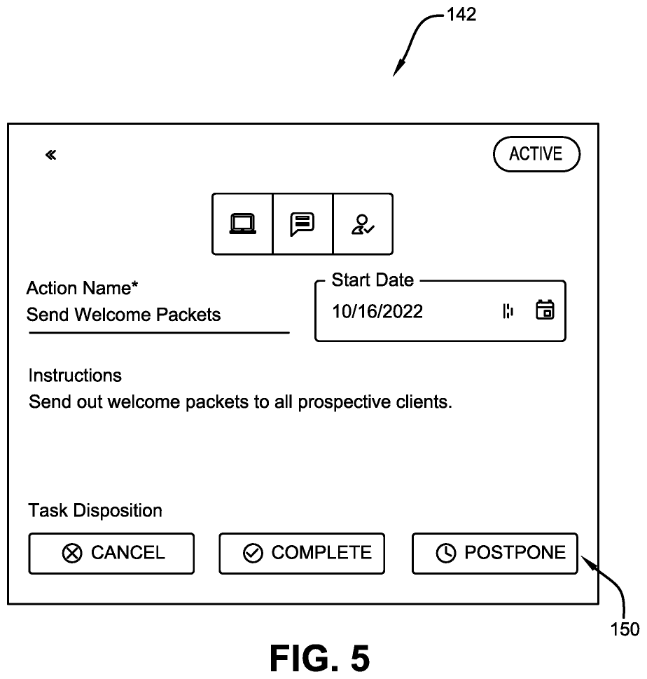

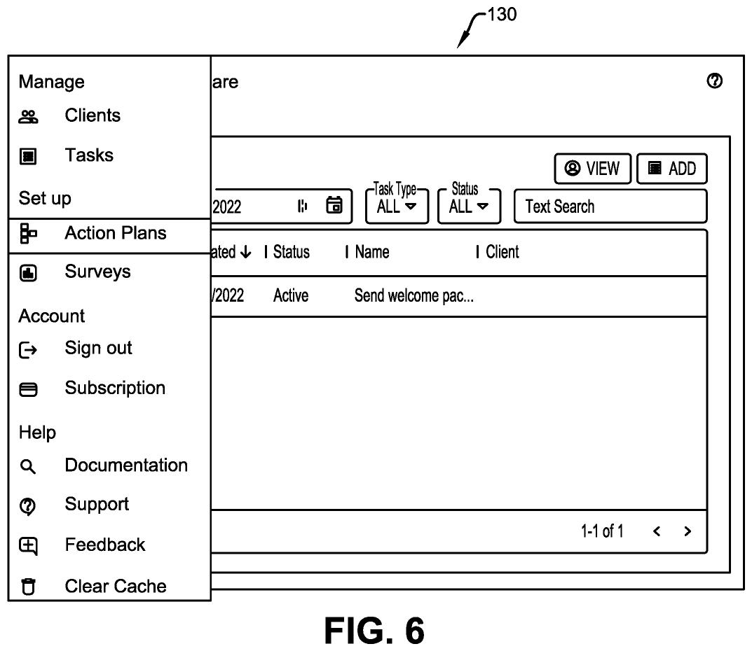

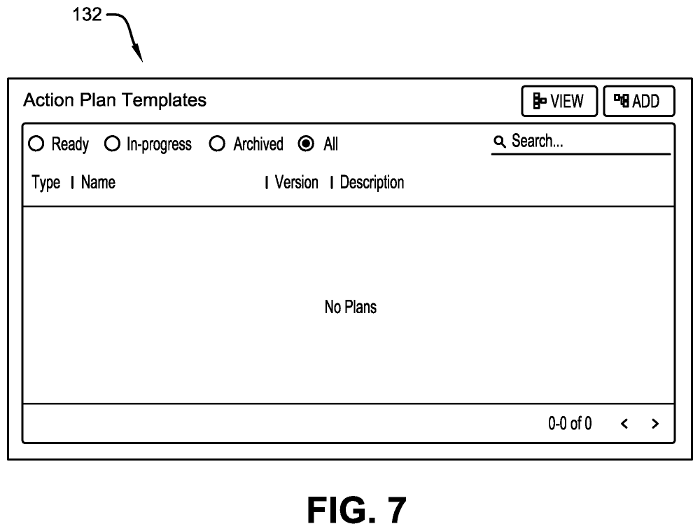

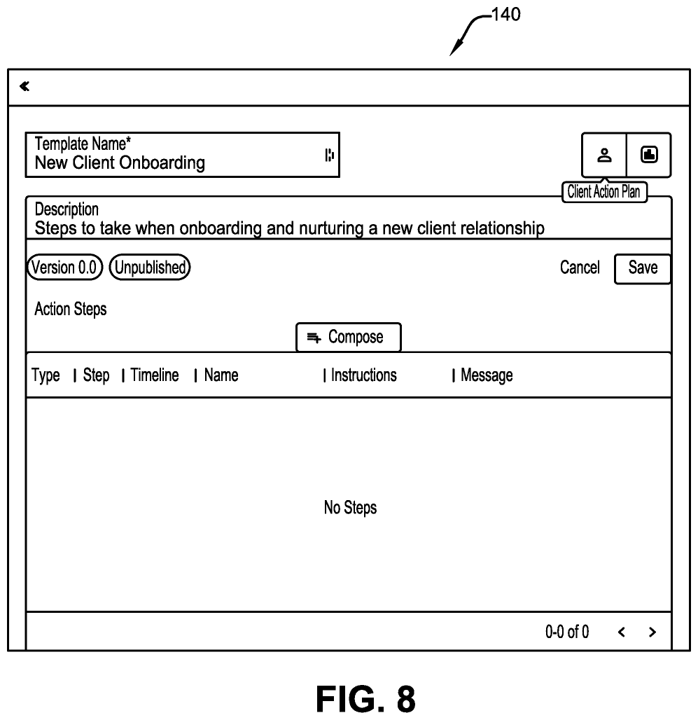

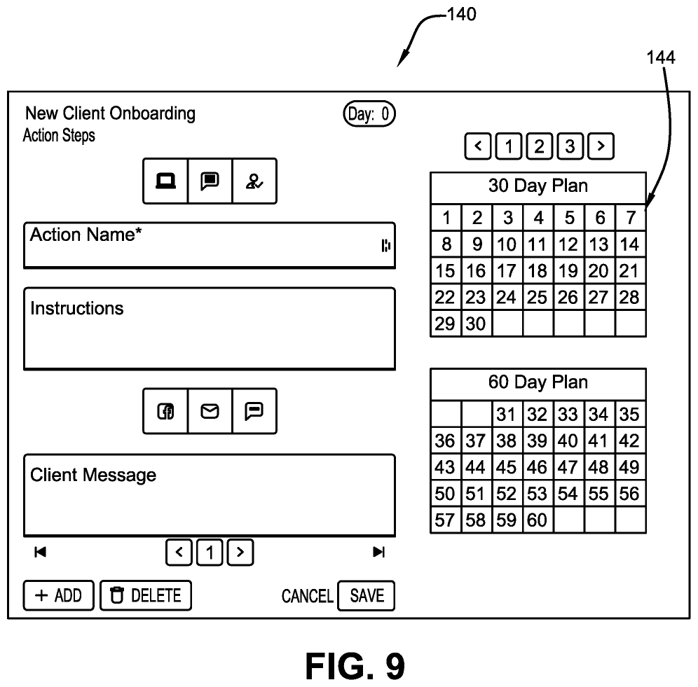

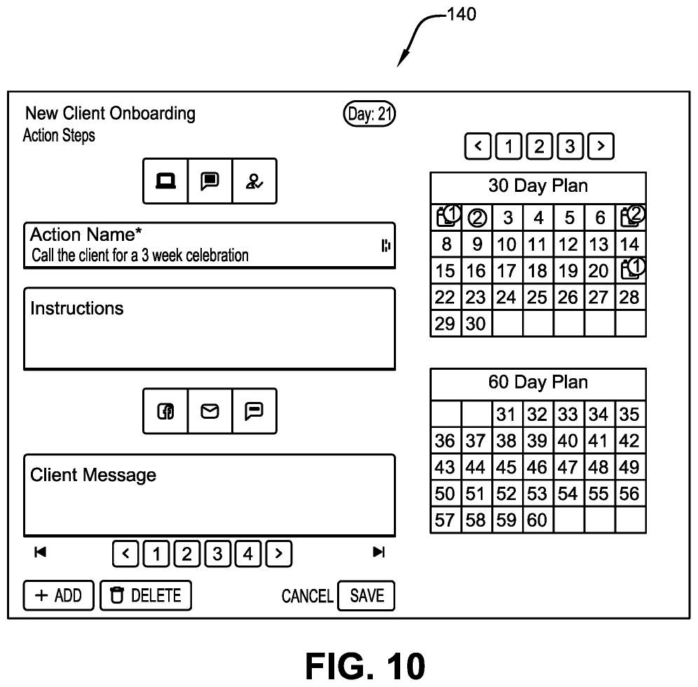

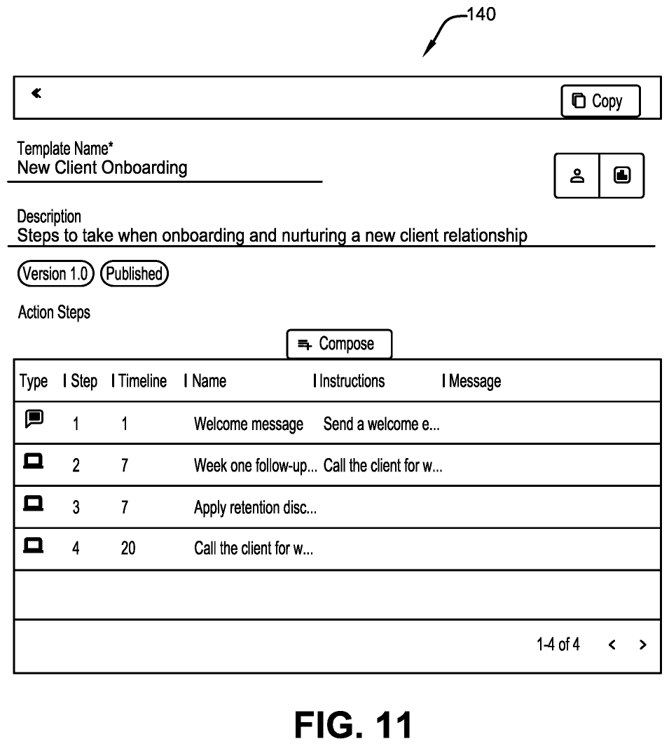

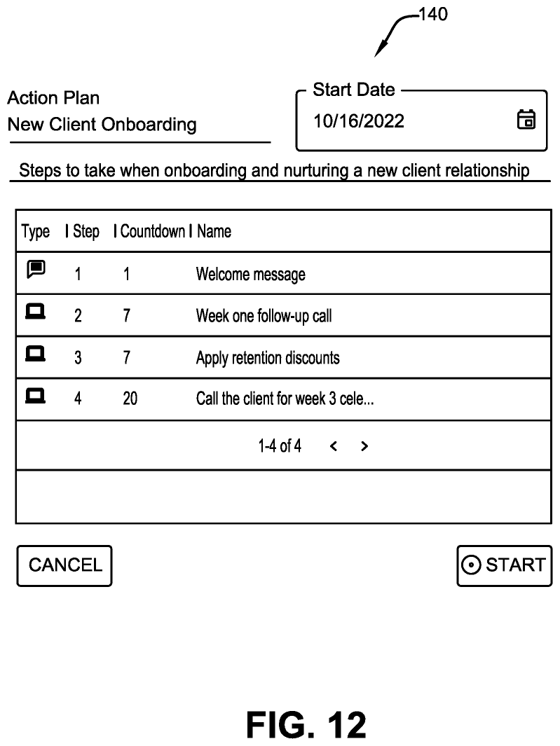

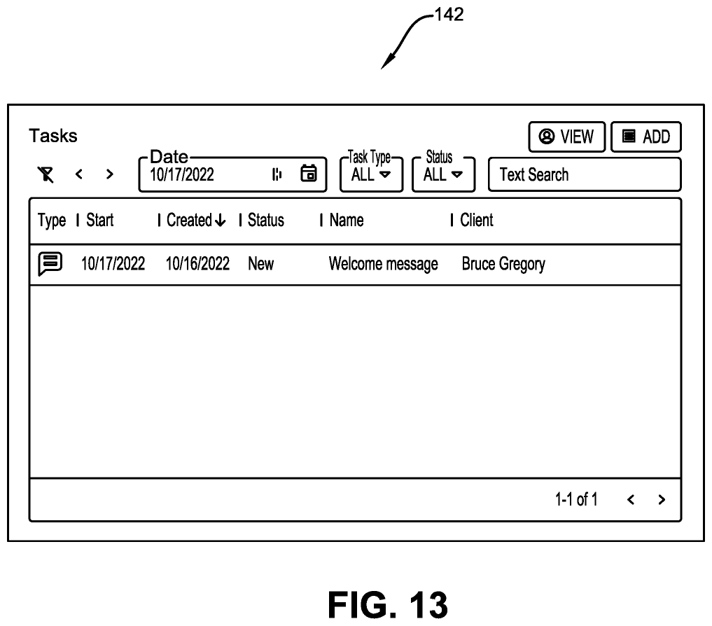

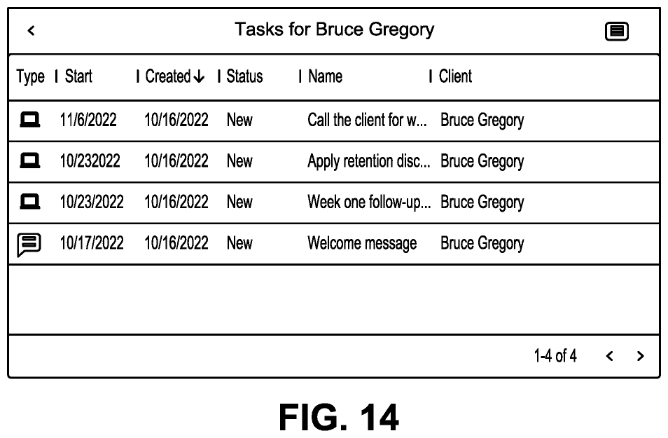

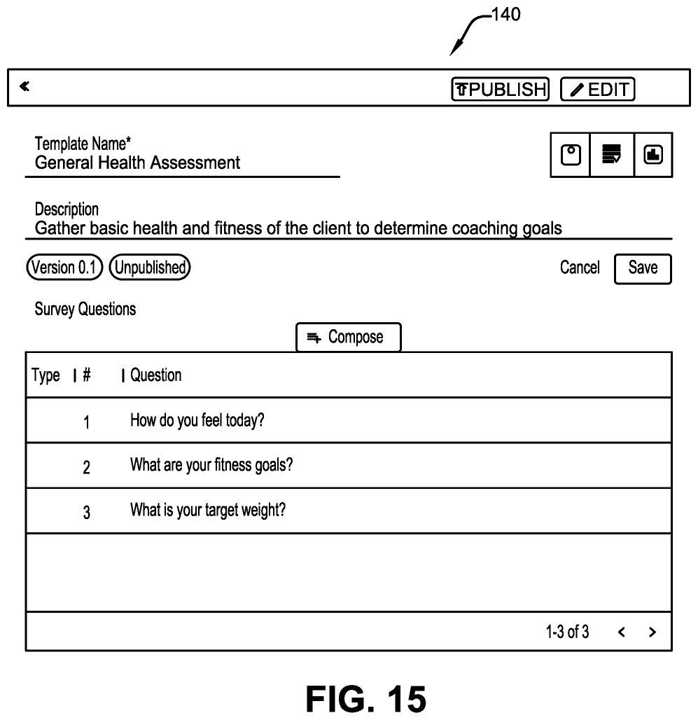

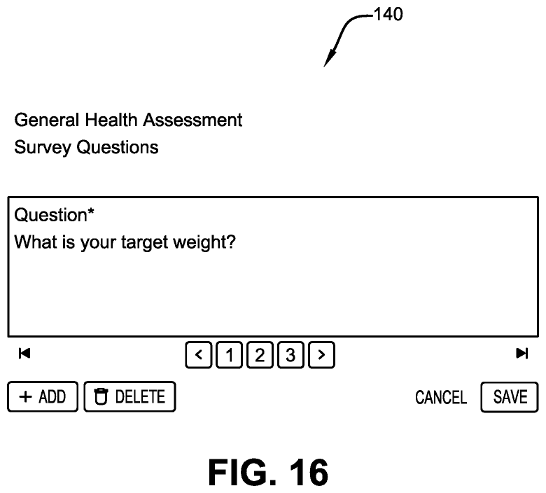

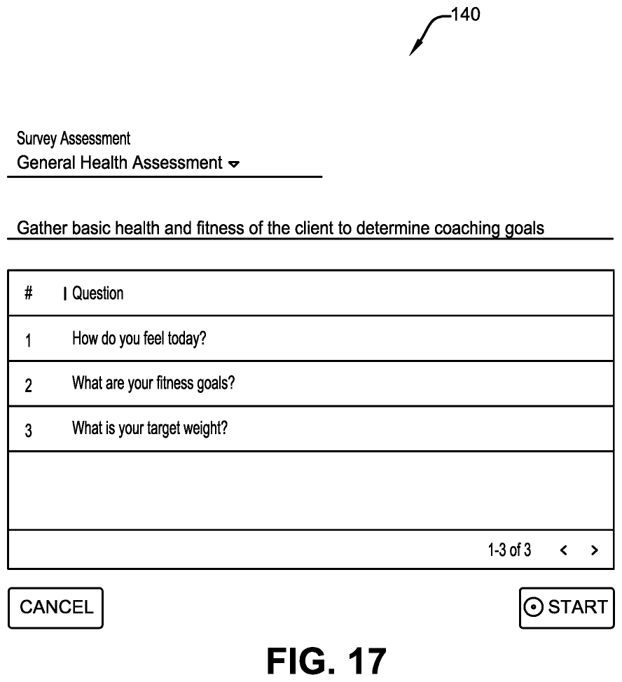

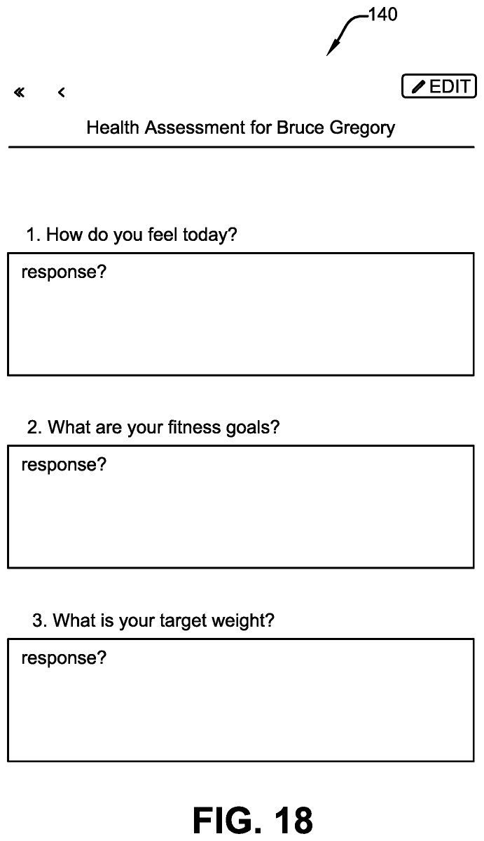

Referring initially to the drawings, FIGS. 1-19 illustrate systems and methods of creating and managing a client contact and interaction system. In one embodiment, the subject matter disclosed and claimed herein, illustrates a client contact and interaction system 100. The client contact and interaction system 100 is a computer system configured to managing client contact and interaction data for a business. The client contact and interaction system 100 models steps for managing client contact and interaction data within a business process.

As illustrated in FIG. 1, the computer system 100 comprises at least one processor 112 in communication with a non-transitory computer-readable storage medium 114 stored on a server 110. The non-transitory computer-readable storage medium 114 contains instructions 120, in the form of a task dashboard application, for implementing the client contact and interaction system 100. A user may access the instructions 120 through a user interface 118 over a network 116, such as the Internet. The user interface 118 may be a laptop computer, a smart phone, a desktop computer, a smart tablet, an interactive display, or any similar user input/access device. The server 110 can be realized through various web-based technologies such as, but not limited to, a Java web-framework, a .NET framework, a personal home page (PHP) framework, or any web-application framework, etc. The server 110 may be maintained by a storage facility management authority or a third-party entity that facilitates service enablement and resource allocation operations of the computer system 100.

The network 116 may include suitable logic, circuitry, and interfaces that may be configured to provide a plurality of network ports and a plurality of communication channels for transmission and reception of data related to operations of various entities (such as the user interface 118 and the server 110) of the computer system 100. In one embodiment, the communication data may be transmitted or received via at least one communication channel or a plurality of communication channels in the network 116. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

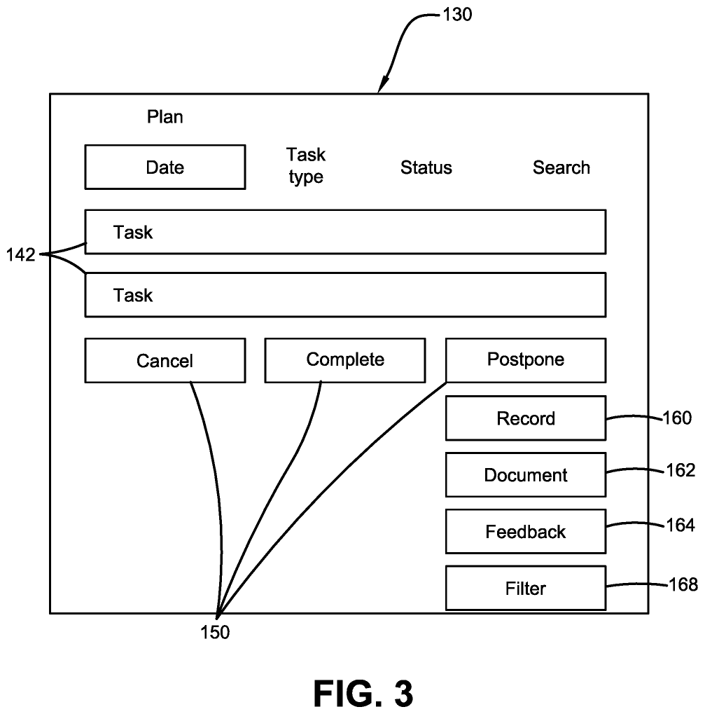

As illustrated in FIGS. 2-3, the client contact and interaction system 100 comprises a task dashboard application 130 and a process template 132. The task dashboard application 130 is a dashboard for hosting and accessing operations of the system 100. The process template 132 is used to generate a plurality of action plans 140. The user can access the client contact and interaction system 100 via an authentication component 134 for security. The authentication component 134 provides secure access to the system 100 through user provisioning and authentication with email, password, multi-factor authentication, or a combination thereof.

As further illustrated in FIGS. 1-18, each of the plurality of action plans 140 is an individualized action plan created from the process template 132 using a plurality of business service data importable to the task dashboard application 140 from a client. Each individualized action plan 140 comprises a plurality of tasks 142 viewable through the task dashboard application 130 on the “Task Dashboard”. A new process template is created by providing a unique template name and an optional description. The user may then “compose” the set of steps that make up the individualized action plan 140 of the process template 132. During composition, the user creates each step as a named task template, such as a task type, task instructions, a message type, and a message template.

The plurality of tasks 142 are dated tasks based on the imported plurality of business service data and are accessible via a calendar 144. The plurality of tasks 142 may be client related or personal tasks. Each task 142 is entered into the calendar 144 and may require a review based on the calendar schedule. The user can select a day from the Action Plan “calendar”, which is the 30/60/90+ day planner. The system 100 may further comprise a filter or search function 168 for filtering or searching the plurality of tasks.

The user can then perform a plurality of business operations 150 on each of the plurality of tasks 142 when due. The plurality of business operations 150 are actions to indicate a status of if each task 142 is complete, canceled, or postponed. The plurality of business operations may further comprise updating the client on a status of the task and other general business operations. The plurality of business operations may be operable via buttons on the dashboard 130. Each action or operation 150 may be recorded and documented via a recording component 160 as a task record indicating an action taken related to each task 142. The user may also add additional information, such as a status of a task, via a notes component 162.

The user may also update the client on the status of each task 142 to elicit a response from the client related to one of the plurality of tasks of from a client survey questionnaire. A message template is a communication medium whereby the user may provide a templated message to be merged with client data (such as client name) which will subsequently be manually or automatically delivered to the respective client on the calculated day of the specific process step (task). Message delivery provides for personalized client digital engagement leveraging automated outbound email or SMS communications, or via copy/paste function for interaction within channels like Facebook Messenger. The client contact and interaction system 100 further comprises a client input 164 configured to receive a feedback to the dashboard 130 via the client input 164. The feedback may be user to modify the relevant individualized action plan 140.

In one example of creating an individual action plan 140, the user selects “Action Plans” from the system menu. This will present the list of Action Plan Templates from which the user may either view, edit, or add a template. To create a new process template the user clicks the “Add” button and provides a unique template name and description and assigns the template type as either a “Client Action Plan” or “Assessment Action Plan”.

The new template will initially be “Unpublished”, meaning that it cannot be used as a reference to create a process instance for a specific client, until it is finally “Published” when the user selects the “Publish” button (only available after modeling of a set of process steps). Also, the system 100 provides a versioning methodology whereby a new template initially will receive a version number of 0.0. For each update to the template, prior to publication, the (sub) version number will be incremented by one, for example 0.0, 0.1, 0.2, etc. . . . . Then, at publication, after all edits and composition of the process steps, the main version number will be incremented by one, and the (sub) version number will be reset to zero, for example 0.0, 0.1, 0.2, publish, 1.0.

Also, at publication, the template status changes from “Unpublished” to “Published” at which point the user may no longer make any changes to the template name, description, or set of process steps. To do so, the user will need to create a new “Version” of the current template by selecting the “Copy” button. In so doing, the system will create a deep copy of the current template to include copies of all process steps, will increment the new copied template (sub) version number by one, and will set the new template status to “Unpublished”. The user may continue to use the existing “Published” version until such time as they have made appropriate changes to the new copy. Once they are ready to publish the new copy, they select the “Publish” button, which will then set the previous template status to “Archived”, set the new template to “Published”, increment the main version number by one, and reset the (sub) version number to zero.

This is an innovative part of the system 100, whereby the user may “model” a business process without dependence on “traditional” methodologies like BPMN or BPEL. Within the action planner, the user creates each step of the action plan by specifying an action name, action type (user, message, or personal), action instructions, and optionally an action message and message type, which may be used for digital engagement directly with a client. For each action, the user also selects a “day” from the action planner pseudo-calendar. Note that each day represents a count of the number of days from the date of the start date that will be assigned to a future process instance of the template type. Days may be selected from the pseudo-calendar over a 30-, 60-, 90-, 120-, 150-, and 180-day view.

For each step, when a day is selected, the system 100 will highlight the day in the planner for the current action step and will increment a counter for the number of steps that share that same day. If the user “deselects” a day for the action step, by clicking on the current selected day in the planner, the system will remove the highlight and decrement the step counter for that day. It is fully acceptable to have actions share the same day. For example, a simple, personal process template like “Make a recipe” might include a set of steps that all occur on the same day. Ordering of each step is specified primarily by the order that each step is added to the process template. Each new step is added to the end of the list of steps and the order number is incremented by one. The system provides a method for reordering each step by allowing for a selected step to be moved backwards or forwards through the list of steps, one step at a time. Note that reordering of a step does not change the day selected from the planner for that step.

After the user completes the process modeling activity and selects the “Save” button, the system presents the list of process steps in a table within the process template view. At this point, the user may continue to edit the template and compose additional steps. Or the user may publish the template which will make it available for automation within a client relationship.

After a process template has been published, it is available for use with a client, whereby the user may start a new process instance from a client record, by selection the “Action Plans” icon, selecting the specific process template of interest, choosing a specific start date for the process, and pressing the “Start” button. Once this is done, the system 100 will create a set of tasks using the process template as a guide, calculating the start date of each task to be the start date of the process plus the number of days identified for that task from the action plan calendar.

On completion of process start, the task dashboard 130 will now present the tasks 142 for this new process instance, specific to the assigned client, on the given day for each task 142. Also, by selecting the “Tasks” icon from the client record, the user may see all the tasks 142 assigned to a given client within the task dashboard 130, rather than just the tasks 142 for every client on a specific day. Tasks 142 may be highlighted in the dashboard 130 to reflect their status relative to the current date. Selected highlight colors may change based on brand design guidelines. However, for example, tasks 142 that are current (those tasks to commence on the current day), may be highlighted in a light blue color. Tasks 142 that are past due, those which have a start date prior to the current date in the dashboard, may be highlighted with a light orange color.

The system 100 further provides a way that the user may elicit responses from a client for a given survey questionnaire. The user may model this questionnaire assessment by creating a survey template (select “Surveys” from the main menu). Within the survey template, the user provides a unique name for the template, an assessment type (health assessment, feedback, or general survey) along with an optional description. Then the user may compose a set of questions for the given survey type. Once the survey is published, the user may start a survey for a specific template and conduct the survey with a client, thereby recording and assigning the client responses to the client record.

Once a survey is published, it is accessible within client record by selecting the “Assessment” button in the bottom navigation bar. From this action, the user may select from the set of published surveys to start and conduct a survey for the selected client. Once the survey is “started”, the system will present a Q&A dialog flow based on the set of modeled survey questions. After adding a new template, the user will then model (or compose) a series of steps that make up the process (action plan). To initiate this activity, the user selects the “Compose” button which will present the process step action planner.

The system 100 may further provide a way that the user may “Share” a process template in the “Action Plan”, or Share a Survey template with another user in the system (as identified by their user ID, which is their email address). This action does not export any material from within the system 100, but instead provides an internal notification to the other user that a template has been shared with them. The recipient user may “Accept” the template by pressing an accept button. The system 100 will then make a copy of the template data into the recipient user's account. This frees the recipient user from having to recreate an “Action Plan” or survey from scratch. The sender (initiator) of the shared template may also “Recall” a shared template if it has not yet been accepted by the recipient. A key feature of this activity is that the data never leaves the core system 100. There is no export or import operation required. This protects the overall system 100 integrity since no nefarious data, such as virus, malware, etc., may be introduced within an import operation.

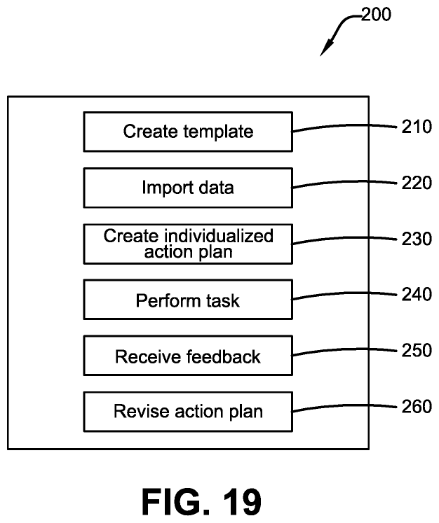

As illustrated in FIG. 19, a method 200 of modeling a plurality of steps within a business process for managing client contact and interaction data is disclosed. The method begins by creating a client contact and interaction system 100. The client contact and interaction system 100 has one or more processors 112 and a non-transitory computer-readable storage medium 114 containing instructions 120 to implement the client contact and interaction system 100.

The method at 210 continues by creating a business process template 132 on a task dashboard application 130. The task dashboard application 130 is securely accessible to a user over a network 116 from a client input device or user interface 118. As 220, the user then may import a plurality of business service data from a client. Next, the plurality of business service data is used to model a plurality of steps within the business process template 132 to create an individualized action plan 140 at 230. The individualized action plan 140 comprises a plurality of dated tasks 142.

At 240, the user may then perform a business operation 150 on each of the dated tasks 142. The business operation 150 may be indicating a status of if each task is complete, canceled, or postponed. Next, the method continues at 250 by receiving a feedback or response 164 from the client. The feedback 164 may be based on the individualized action plan 140, a status of each of each of the dated tasks 142, or a survey. The survey may be a client questionnaire. Finally at 260, the individualized action plan may be revised based on the feedback 164.

In one example of the method 200, the system 100 is used to instantiate a process instance (Action Plan) and related tasks (process steps) based on a specific business process template. After a process template and its collection of steps is modeled (composed), the user may “start” an instance of a template for a specific client, to commence on a specific future date. In so doing, the system will create a new Action Plan which includes generation of a set of tasks based on the process template collection. The system 100 will calculate a specific date for each task in the template which is equivalent to the process instance start date+the day (integer) selected from the 30/60/90-day planner for that specific step. The benefit of this feature is that it eliminates manual calendar management which may become burdensome as the business grows. For instance, if the user has twenty clients within an Action Plan that represents ten tasks, that potentially requires the user to manage two hundred (200) specific dates on a calendar. Ultimately, without such automated methods, the user spends more time managing their calendar than engaging with their clients.

The method 200 may further be used to adjust an Action Plan and automate recalculation of task dates. Business processes may follow a defined plan; however, they sometimes do not execute as expected due to external variables that effect adherence to a task date. For instance, the user may be waiting on notification of successful delivery of an order before proceeding to the subsequent step prescribed by the process template. In these scenarios, the system provides a method whereby the user may “postpone” a task to a future date, at which point the user has a reasonable expectation that the predecessor tasks have completed. By specifying a future date for a task, the system will then recalculate all start dates for future tasks of that process instance, relative to their position in the related process template (as specified by their respective “day” value selected from the 30/60/90-day action plan calendar). In so doing, this automation method relieves the user of having to manually adjust all subsequent dates.

Finally, the method 200 may be further used to model client surveys. Following a similar method for process templates, the system provides a methodology for modeling survey questionnaires. Each survey template is a uniquely named assessment that includes a set of questions which may be used to assess some aspect of a client, to elicit feedback from a client, or as a general query and any given topic.

It is contemplated that the system 100 and method 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the foregoing, the system 100 and method 200 of the present invention and its various structural components can be of any suitable size, shape, and configuration as is known in the art without affecting the overall concept of the invention, provided that it accomplishes the above stated objectives. One of ordinary skill in the art will appreciate that the shape and size of the system 100 and method 200 and its various components and material, as shown in the FIGS. are for illustrative purposes only, and that many other shapes and sizes of the system 100 and method 200 are well within the scope of the present disclosure. Although the dimensions of the system 100 and method 200 are important design parameters, the system 100 and method 200 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A client contact and interaction system having one or more processors and a non-transitory computer-readable storage medium containing instructions configured to cause the one or more processors to:
create a process template for generating a plurality of action plans;
create a task dashboard for hosting the plurality of action plans;
securely import a plurality of business service data from a client;
generate an individualized action plan from the process template using the plurality of business service data;
create a plurality of tasks based on the individualized action plan; and
perform an action for each of the plurality of tasks.

2. The client contact and interaction system of claim 1, wherein each task is a client related task or a personal task.

3. The client contact and interaction system of claim 2, wherein each task requires a review based on a calendar schedule.

4. The client contact and interaction system of claim 1, wherein a user of the system is authenticated via a multi-factor authentication.

5. The client contact and interaction system of claim 1, wherein the action is an indication that one of the plurality of tasks is complete.

6. The client contact and interaction system of claim 1, the action is an indication that one of the plurality of tasks is canceled.

7. The client contact and interaction system of claim 1, the action is an indication that one of the plurality of tasks is postponed.

8. The client contact and interaction system of claim 1 further comprising creating a task record for indicating an action taken related to each task.

9. The client contact and interaction system of claim 1 further comprising eliciting a response from the client related to one of the plurality of tasks.

10. The client contact and interaction system of claim 1 further comprising eliciting a response from the client from a client survey questionnaire.

11. The client contact and interaction system of claim 10, wherein the client survey questionnaire is used to update the individualized action plan.

12. The client contact and interaction system of claim 1 further comprising a filter function for searching the plurality of tasks.

13. A computer system comprising:
at least one processor in communication with a non-transitory computer-readable storage medium and configure to implement a client contact and interaction system, wherein the client contact and interaction system comprises:
a task dashboard application; and
a process template for generating a plurality of action plans, wherein each action plan is individualized using a plurality of business service data imported from a client into the process template; and
wherein a plurality of tasks is generated for each individualized action plan based on the imported plurality of business service data; and
wherein a user can perform a plurality of business operations on each of the plurality of tasks using the at least one processor to keep track of a status of each task.

14. The client contact and interaction system of claim 13, wherein the plurality of business operations comprise canceling, completing, and postponing each task.

15. The client contact and interaction system of claim 13, wherein the plurality of business operations comprises documenting a note related to a status of each task.

16. The client contact and interaction system of claim 13, wherein the plurality of business operations comprises updating a client on a status of each task.

17. The client contact and interaction system of claim 13, wherein each individualized action plan is modifiable.

18. A method of modeling a plurality of steps within a business process for managing client contact and interaction data, the method comprising the steps of:
creating a client contact and interaction system having one or more processors and a non-transitory computer-readable storage medium containing instructions to implement the client contact and interaction system;
creating a business process template;
importing a plurality of business service data from a client;
modeling a plurality of steps within the business process template based on the plurality of business service data to create an individualized action plan comprising a plurality of dated tasks;
performing a business operation on each of the dated tasks.

19. The method of claim 18 further comprising receiving a feedback from a client based on the individualized action plan and a status of each of the dated tasks.

20. The method of claim 19 further comprising revising the individualized action plan based on the feedback.
